(19) United States
(12) Patent Application Publication
(10) Pub. No.: US 2008/0031445 A1
(43) Pub. Date: Feb. 7, 2008

(54) Key Binding Method and Applications Capable of Dynamic Key Generation

(75) Inventors: Chih-Jen Lee, Taiwan (CN); Yi-Wen Chang, Taiwan (CN)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/571,712

(22) PCT Filed: Jul. 12, 2005
(86) PCT No.: PCT/JP05/13223

§ 371 Date: Jan. 5, 2007

(30) Foreign Application Priority Data
Jul. 19, 2004 (CN) 2004-10069910.1

(51) Int. Cl. H04L 9/00

(52) U.S. Cl. 380/44

(57) ABSTRACT

A key binding method capable of dynamic key generation includes the following steps: (a) dynamically generating key information for an identification-pending device; (b) transforming the key information into an image; and (c) transferring the key information to an object device through reading of the image. Applications of the method are also disclosed.

### TECHNICAL FIELD

The invention relates to a key binding method and applications thereof, more particularly to a key binding method and applications capable of dynamic key generation.

### BACKGROUND ART

Many security services, such as authentication, access control, data confidentiality, etc., have been developed to protect a network from possible attack. Mechanisms that support these security services are mostly based on cryptographic techniques. However, if there is no appropriate management of keys that are in use, these cryptographic techniques are basically useless.

Key management is a procedure of processing and controlling cryptographic keys and other relevant information (such as initial values) during the life cycles of keys in a cryptosystem. At the start, some initial values (key binding) must be provided in order to enable subsequent operations of key management, such as ordering, generation, distribution, storing, and loading of key information, etc., thereby ensuring that the requisite security service has adequate strength.

U.S. Pat. No. 6,523,116 discloses the use of bar-coded data to present the public key of a person, which is used for accessing information in a database. U.S. Pat. No. 6,487,403 discloses a provisioning device capable of transferring provisioning information (including an authentication key) to a wireless device. The transfer of the provisioning information is activated via a wireline link between a transceiver antenna of the wireless device and the provisioning device. U.S. Patent Application Publication No. US2003/0007641 discloses the use of key data to encrypt/decrypt data so as to protect the data that is being communicated. Key data are exchanged through infrared rays. U.S. Pat. No. 6,510,520 and U.S. Patent Application Publication No. US2003/0159042 disclose downloading of data from a digital camera to a secure storage device for protecting the data. U.S. Pat. No. 5,442,706 discloses the physical transport of a data storage medium that stores encrypted data for transferring the encrypted data.

The aforesaid conventional techniques already disclosed some procedures of automatic input of keys, particularly U.S. Pat. No. 6,487,403, U.S. Patent Application Publication No. US2003/0007641, and U.S. Pat. No. 5,442,706. In U.S. Pat. No. 6,487,403, although the authentication keys are transferred to a wireless device through a standard wireless interface, a specified wireless device is activated in a transient mode (provisioning mode), not in any time to exchange and manage keys. In U.S. Patent Application Publication No. US2003/0007641, key data are exchanged through infrared rays. Hence, data exchange must be performed through a direct line-of-sight such that data transmission will be interrupted in case an object is at the path of the line-of-sight. Moreover, U.S. Pat. No. 5,442,706 fails to disclose that the data stored in the data storage medium and to be transferred can be used for key exchange and key management. Furthermore, the aforesaid references fail to disclose a key binding method in which keys are generated dynamically to render the key binding procedure more secure and subsequent communication between devices safer.

### DISCLOSURE OF INVENTION

Therefore, the object of the present invention is to provide a key binding method capable of dynamic key generation so as to render the key binding procedure of a device more secure and so that subsequent communication between devices can be made safer.

According to a first aspect of the present invention, a key binding method capable of dynamic key generation comprises the following steps: (a) dynamically generating key information for an identification-pending device; (b) transforming the key information into an image; and (c) transferring the key information to an object device through reading of the image.

Moreover, another object of the present invention is to provide a key binding system capable of dynamic key generation so as to render the key binding procedure of a device more secure and so that subsequent communication between devices can be made safer.

According to a second aspect of the present invention, a key binding system capable of dynamic key generation comprises an identification-pending device, a reading device, and an object device. The identification-pending device includes a key generating unit for dynamically generating key information, and a transformation unit for transforming the key information into an image. The reading device is used to read the image from the identification-pending device. The object device is used to receive the image from the reading device and to interpret the image in order to recover the key information.

In addition, yet another object of the present invention is to provide an identification-pending device capable of dynamic generation of key information so as to render the key binding procedure of the identification-pending device more secure and so that subsequent communication among several identification-pending devices can be made safer.

According to a third aspect of the present invention, an identification-pending device capable of dynamic generation of key information comprises a key generating unit and a transformation unit. The key generating unit is used to generate key information dynamically. The transformation unit is used to transform the key information into an image.

### BRIEF DESCRIPTION OF DRAWINGS

Other features and advantages of the present invention will become apparent in the following detailed description of the preferred embodiment with reference to the accompanying drawings, of which:

FIG. 1 is a block diagram of the preferred embodiment of a key binding system capable of dynamic key generation according to the present invention; and

FIG. 2 is a flowchart of the preferred embodiment of a key binding method capable of dynamic key generation according to the present invention.

### BEST MODE FOR CARRYING OUT THE INVENTION

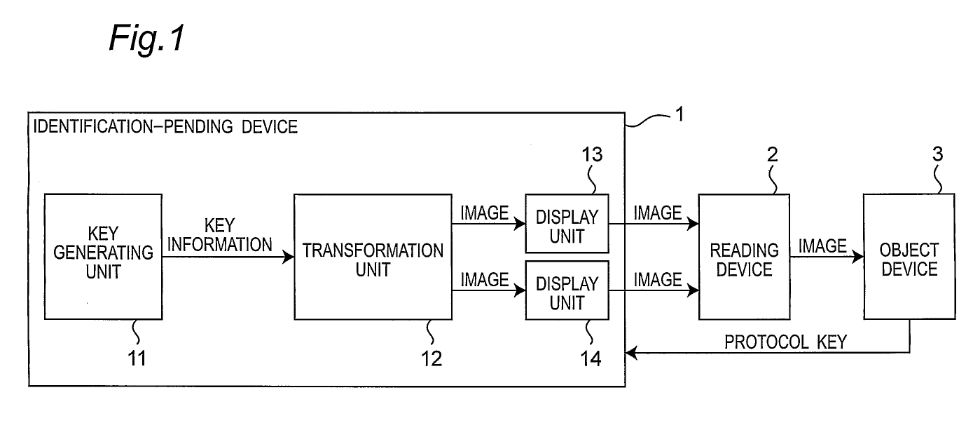

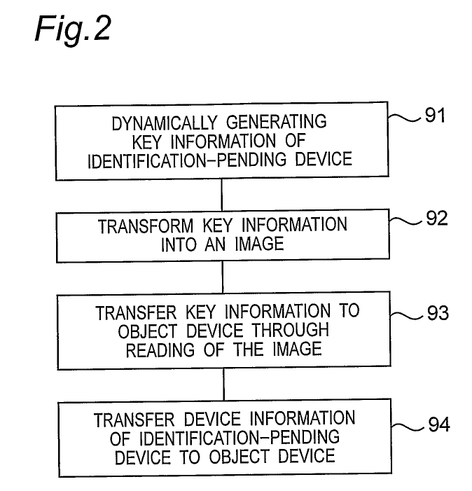

Referring to FIGS. 1 and 2, the key binding system capable of dynamic key generation according to the present invention is used to transfer key information for key binding. The key binding system of the preferred embodiment includes an identification-pending device 1, a reading device 2, and an object device 3. The original key information of the identification-pending device 1 may be presented in a plain text or encoded text format.

In practice, the identification-pending device 1 may be embodied in a home appliance, a consumer electronic device, or computer peripheral device that is disposed in a premise and that is required to undergo identification by the object device 3 so as to become a member of a home network. The identification-pending device 1 includes a key generating unit 11, a transformation unit 12, a display unit 13, and an output unit 14. The feature of the present invention resides in that the key generating unit 11 is used to generate key information dynamically. A conventional identification-pending device does not have the key generating unit 11, and is thus unable to generate the key information dynamically and in real-time. Instead, the conventional identification-pending device uses fixed key information in a form for presentation. For example, the fixed key information may be presented in a bar-coded format and is labeled on a surface of the identification-pending device beforehand. Since the identification-pending device 1 in this invention has sufficient computing capability, as shown in step 91, at the start of the key binding method of the present invention, the key generating unit 11 can be used to generate key information dynamically for use during subsequent key management. That is, based on pre-configured settings of the identification-pending device 1, keys can be generated dynamically and in real time, or generated dynamically and automatically after a period of time.

The transformation unit 12 is capable of transforming the key information into an image. Therefore, as shown in step 92, the transformation unit 12 can be used to transform the key information that is originally presented in the plain text or encoded text format into an image of a preset format.

The display unit 13 is used to show the image generated by the transformation unit 12 thereon. While the display unit 13 is exemplified using a liquid crystal display (LCD) module in this embodiment, it should not be limited thereto. The output unit 14 is used to print the image generated by the transformation unit 12 on a piece of paper for output. It should be noted that FIG. 1 only illustrates the preferred embodiment of the key binding system according to the present invention, and it is not implied that the identification-pending device 1 must include the display unit 13 and the output unit 14 at the same time. In practice, the function of the present invention can be achieved even if the identification-pending device 1 includes only one of the display unit 13 and the output unit 14.

The reading device 2 is used to read the image shown on the display unit 13 or printed out by the output unit 14. If the reading device 2 is used to read the image shown on the display unit 13, the reading device 2 is preferably a device having a digital picture taking capability, such as a digital camera, a network camera, etc. On the other hand, if the reading device 2 is used to read the image printed out by the output unit 14, the reading device 2 may be a scanner for scanning the image on the piece of paper or a barcode reader.

Therefore, as shown in step 93, the reading device 2 is used to read the image shown on the display unit 13 or printed out by the output unit 14, and the image is subsequently transmitted to the object device 3. Hence, the purpose of transferring the key information to the object device 3 can be achieved.

Moreover, as shown in step 94, the key binding method according to the present invention further includes a step of transferring relevant device information of the identification-pending device 1 to the object device 3. The identification-pending device information can include the name, classification, model number, and any other relevant information for describing the identification-pending device 1. In practice, the identification-pending device information can be transferred to the object device 3 using any appropriate method, such as direct input through a keyboard (not shown) of the object device 3. Alternatively, the key information can include the relevant identification-pending device information such that the identification-pending device information can also be transformed into an image of a preset format through the transformation unit 12 for subsequent transfer to the object device 3 through the display unit 13 (or the output unit 14) and the reading device 2.

The object device 3, which can be exemplified by a server computer, is not only for receiving the image transmitted from the reading device 2, but is also for processing the image by interpreting the image in order to recover the key information (including relevant identification-pending device information) in some internal format (such as Base64-encoded key). Next, the object device 3 proceeds with key management according to the key information received from a plurality of the identification-pending devices 1, and performs computations to generate protocol keys conforming to the protocol among the identification-pending devices 1 and the object device 3. Then, the protocol keys can be transmitted from the object device 3 to the identification-pending devices 1 in a wired or wireless manner (depending on the connection method between the object device 3 and the identification-pending device 1). Therefore, secure communication can proceed using the protocol keys between different key-bound identification-pending devices 1 and between the object device 3 and a specified one of the identification-pending devices 1, and unsafe communication of the identification-pending devices 1 and the object device 3 with other non-key-bound devices can be avoided.

In sum, the key binding method and applications capable of dynamic key generation according to this invention are characterized in that, by using the key generating unit 11 of the identification-pending device 1 to generate the required key information dynamically, and by subsequently using the transformation unit 12 of the identification-pending device 1 to transform the key information into an image file, that is transmitted to the object device 3 after being read by the reading device 2, subsequent communication between different identification-pending devices 1 and between the object device 3 and a specified one of the identification-pending devices 1 is made more secure.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

### INDUSTRIAL APPLICABILITY

The present invention is applicable to a key binding method and an application thereof.

1. A key binding method capable of dynamic key generation, comprising the following steps:
(a) dynamically generating key information for an identification-pending device;
(b) transforming the key information into an image; and
(c) transferring the key information to an object device through reading of the image.

2. The key binding method capable of dynamic key generation as claimed in claim 1, wherein, in step (c), the image is read by a reading device.

3. The key binding method capable of dynamic key generation as claimed in claim 2, wherein the reading device is a digital camera.

4. The key binding method capable of dynamic key generation as claimed in claim 2, wherein the reading device is a network camera.

5. The key binding method capable of dynamic key generation as claimed in claim 2, wherein the reading device is a scanner.

6. The key binding method capable of dynamic key generation as claimed in claim 2, wherein the reading device is a barcode reader.

7. The key binding method capable of dynamic key generation as claimed in claim 1, wherein the key information includes identification-pending device information.

8. The key binding method as claimed in claim 1, further comprising a step of transferring device information of the identification-pending device to the object device.

9. A key binding system capable of dynamic key generation, said key binding system being adapted to transfer key information for key binding, said key binding system comprising:
an identification-pending device including a key generating unit for dynamically generating the key information, and a transformation unit for transforming the key information into an image;
a reading device for reading the image from said identification-pending device; and
an object device for receiving the image from said reading device and for interpreting the image to recover the key information.

10. The key binding system capable of dynamic key generation as claimed in claim 9, wherein said reading device is one of a digital camera and a network camera.

11. The key binding system capable of dynamic key generation as claimed in claim 10, wherein said identification-pending device further includes a display unit for showing the image thereon.

12. The key binding system capable of dynamic key generation as claimed in claim 9, wherein said reading device is one of a scanner and a barcode reader.

13. The key binding capable of dynamic key generation as claimed in claim 12, wherein said identification-pending device further includes an output unit for outputting the image.

14. The key binding system capable of dynamic key generation as claimed in claim 9, wherein the key information includes identification-pending device information.

15. An identification-pending device capable of dynamic generation of key information, the key information being transferable to an object device via a reading device, said identification-pending device comprising:
a key generating unit for dynamically generating the key information; and
a transformation unit for transforming the key information into an image.

16. The identification-pending device capable of dynamic generation of key information as claimed in claim 15, further comprising a display unit for showing the image thereon, the reading device being one of a digital camera and a network camera for capturing the image shown on the display unit.

17. The identification-pending device capable of dynamic generation of key information as claimed in claim 15, further comprising an output unit for outputting the image, the reading device being one of a scanner for scanning the image printed out by said output unit, and a barcode reader.

18. The identification-pending device capable of dynamic generation of key information as claimed in claim 15, wherein the key information includes identification-pending device information.
